(19) United States
(12) Patent Application Publication
(10) Pub. No.: US 2016/0284221 A1
(43) Pub. Date: Sep. 29, 2016

(54) ROUTE PLANNING FOR UNMANNED AERIAL VEHICLES

(71) Applicant: Matternet, Inc., Menlo Park, CA (US)

(72) Inventors: Christopher HINKLE, San Francisco, CA (US); Andreas RAPTOPOULOS, Palo Alto, CA (US); Kendall LARSEN, Palo Alto, CA (US); Ido BARUCHIN, San Francisco, CA (US)

(21) Appl. No.: 15/081,195

(22) Filed: Mar. 25, 2016

Related U.S. Application Data
(60) Provisional application No. 62/138,914, filed on Mar. 26, 2015.
(60) Provisional application No. 62/138,910, filed on Mar. 26, 2015.

(51) Int. Cl. G08G 5/00; B64C 39/02

(52) U.S. Cl. CPC G08G 5/0034; G08G 5/0039; G08G 5/0004; B64C 39/024; B64C 2201/00

(57) ABSTRACT

A system and process for dynamically determining a route for an unmanned aerial vehicle (UAV) is provided. In one example, at a computer system including one or more processors and memory, the process includes receiving a route request, the route request including an origin location and destination location for a UAV, receiving geospatial information associated with the origin location and the destination location, the geospatial information comprising at least one of physical obstacles and no-fly zones, determining a route of the UAV from the origin location to the destination location based at least in part on the geo-spatial information, and causing the route to be communicated to the UAV.

### CROSS-REFERENCE TO RELATED APPLICATIONS

This Application claims the benefit of U.S. Provisional Application No. 62/138,914 entitled “UNMANNED AERIAL VEHICLE” and 62/138,910 entitled “SYSTEMS AND METHODS FOR UNMANNED AERIAL VEHICLE ROUTE PLANNING”, both filed on Mar. 26, 2015, and both of which are incorporated herein by reference in its entirety for all purposes. This application is further related to U.S. patent application Ser. No. 13/890,165 filed May 8, 2013, which is hereby incorporated by reference in its entirety.

### FIELD

The present disclosure relates generally to unmanned aerial vehicles (UAVs). More particularly, the present disclosure relates to route planning and communication of route detail to UAVs via remote devices and cloud services.

### BACKGROUND

Unmanned aerial vehicles (UAVs) or drones are increasingly being used for various personal or commercial applications. Conventional methodology for the control of UAVs includes manual navigation or communication via a base station. A human operator can pilot a UAV while being on the ground using vehicle telemetry for remote manual operation.

### BRIEF SUMMARY

According to one aspect, a system and process for dynamically determining a route for an unmanned aerial vehicle (UAV) is provided. In one example, at a computer system including one or more processors and memory, the process includes receiving a route request, the route request including a start or origin location and an end or destination location for a UAV. The route request may be input by a user of a mobile electronic device, e.g., a smart phone or tablet computer. The process further includes receiving geospatial information associated with the origin location and the destination location, the geospatial information comprising at least one of physical obstacles and no-fly zones. The geospatial information may be received from a remote location, e.g., a server or cloud application service in communication with the electronic device. The process further includes determining a route of the UAV from the origin location to the destination location based at least in part on the geo-spatial information, and causing the route to be communicated to the UAV. The route may be determined by the electronic device or by a remote device and communicated to the UAV via a cloud service.

The geospatial information may include vertical information and horizontal information associated with possible routes between the origin and destination locations. For example, vertical and horizontal information may include terrain data (elevation profile of terrain between origin and destination, buildings, powerlines, cellular towers, or other infrastructure); airspace data, such as data demarcating difference airspace classes and no fly zones; population density data, or data relating to areas of high concentration of people during certain times of the day, and the like.

When determining a route, a horizontal route may first be determined based on the geospatial information and then a vertical route based on the geo-spatial information and the determined horizontal route. The geospatial information may include a minimum and maximum altitude for the route relative to ground, and may further include physical obstacles and no fly zones.

In one example, the routing process can be initiated via a mobile electronic device, e.g., via a smartphone or tablet computer running an application. The route may be determined in whole or in part by the mobile electronic device. In other examples, the route may be determined in whole or in part remotely from the mobile electronic device, e.g., by an application or cloud service in communication with the remote electronic device.

According to another aspect, a system is provided comprising a UAV that includes an onboard computer that is capable of receiving route information (e.g., via a cloud system over a wireless connection) and operate autonomously from an origin location to a destination location. The route information can be initiated from a user selecting a destination for the UAV on a mobile device. For example, an application running on a device may receive geospatial data based on the origin and destination locations, and generate a route for sending to the UAV.

In one example, the UAV may further report operating parameters (e.g., longitude, latitude, altitude, pitch, roll, velocities in 3 different axes, battery voltage, battery current, and so on) to a time-series geospatial database. The values can be stored and analyzed for detecting abnormal patterns that may be symptomatic of impeding failure, or flag maintenance actions (and in extreme cases the vehicle may be instructed to land, or not be given authorization for take-off before maintenance takes place). In some examples, the UAV may run a fully redundant altitude and attitude estimation system such that if it loses control due to weather, a lost propulsion unit, loses main battery source, or other cause, the UAV may deploy a parachute and sound a siren during a controlled landing.

The terminology used in the description of the various described embodiments herein is for the purpose of describing particular embodiments only and is not intended to be limiting. As used in the description of the various described embodiments and the appended claims, the singular forms “a”, “an,” and “the” are intended to include the plural forms as well, unless the context clearly indicates otherwise.

It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The details of one or more embodiments of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

The following drawings and the associated descriptions are provided to illustrate embodiments of the present disclosure and do not limit the scope of the claims.

FIGS. 1A-B illustrate example unmanned aerial vehicle systems, according to some embodiments of the present disclosure.

FIG. 2 is a flowchart illustrating an example route planning process, according to some embodiments of the present disclosure.

FIG. 3 is a flowchart illustrating an example horizontal route planning process, according to some embodiments of the present disclosure.

FIGS. 4A-4D are example diagrams illustrating a horizontal route determination process, according to some embodiments of the present disclosure

FIG. 5 is a flowchart illustrating an example vertical route planning process, according to some embodiments of the present disclosure.

FIG. 6 illustrates an example unmanned aerial vehicle, according to some embodiments of the present disclosure.

FIG. 7A is a diagram illustrating an example computing system of an unmanned aerial vehicle, according to some embodiments of the present disclosure.

FIG. 7B is a flowchart illustrating an example emergency process for controlling an unmanned aerial vehicle, according to some embodiments of the present disclosure.

FIGS. 8A-8C illustrate example diagrams of configurable payload containers and/or power sources, according to some embodiments of the present disclosure.

FIG. 9 is a diagram illustrating a computing system with which certain embodiments discussed herein may be implemented.

FIGS. 10A-10D illustrate example screen shots of a remote electronic device illustrating certain features described.

### DETAILED DESCRIPTION

The following description sets forth exemplary systems and methods for transportation using UAVs. The illustrated components and steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

Due to the ever-increasing growth of highly developed areas, such as cities, or the continually growing needs of undeveloped regions, such as isolated rural areas, there is a need for efficient transportation and/or deliveries of goods. Transportation of goods via UAVs may help satisfy these needs. Traditional unmanned aerial vehicles are manually operated by a human. For example, a human pilots an aircraft while the human is located on the ground by reviewing aircraft telemetry and an onboard camera from the aircraft. However, manual operation of one or more UAVs may be costly and/or inefficient. Thus, there may be a need for autonomous and/or semi-autonomous (“highly-automated”) navigation of UAVs. Autonomous and/or semi-autonomous navigation of UAVs may rely on or include efficient route planning of unmanned aerial vehicles that avoids obstacles and/or designated areas

Generally described, aspects of the present disclosure relate to a UAV and a computing system for autonomous and/or semi-autonomous navigation of a UAV. In particular, systems and methods are disclosed herein for autonomous and/or semi-autonomous route planning of a UAV. For example, according to some embodiments, a user computing device accesses geospatial data of a geographic area. In one example, a user selects a start/origin and an end/destination location within the geographic area. The user computing device determines a horizontal route from the start to the end location by avoiding obstacles within the geographic area. Continuing with the example, the user computing device uses computational geometry, such as a convex hull operation, to generate an obstacle avoidance shape. User computing device then determines one or more routes around the obstacle avoidance shape and determines whether the route intersects additional obstacles. If the route intersects additional obstacles, user computing device adds the obstacles to the obstacle avoidance shape, such as by repeating the convex hull operation, and determines one or more new routes around the updated obstacle avoidance shape. In some embodiments, the horizontal route is further optimized by removing unnecessary segments of the route, which may be determined by the user computing device by removing the segment and checking whether the updated path intersects one or more obstacles.

In some embodiments, user computing device determines a vertical route from the horizontal route. An example vertical route determination process includes accessing vertical thresholds such as altitudes defined by airspace regulations and/or particular maximum or minimum flight altitudes. Example vertical route determination further includes determining local minimum and/or maximum altitudes of the horizontal route using the vertical thresholds. The local minimum and/or maximum altitudes are used to determine an initial vertical route that obtains the highest altitude without subsequently having to decrease in altitude. In some embodiments, selecting the highest altitude without subsequent decreases improves energy efficiency and/or reduces the likelihood of encountering obstacles. Continuing with the example, intermediary waypoints are selected between waypoints of the route to identify local minimum and/or maximum threshold violations. If any violations are detected, the example process corrects the vertical route and splits the segment into sub portions and repeats the violation detection and correction process recursively until no additional violations are detected in the vertical route. In some embodiments, user computing device combines horizontal and vertical routes and transmits the combined route to an application server and/or UAV.

Generally described, aspects of the present disclosure further relate to an unmanned aerial vehicle and/or a distributed unmanned aerial vehicle system. For example, an unmanned aerial vehicle may include application processor, one or more propulsion sensors, a communication device wirelessly connected to a cellular network, and additional components. The unmanned aerial vehicle may receive instructions via a user computing device via a messaging queue. Moreover, the unmanned aerial vehicle may transmit telemetry and sensor data to a system for storage within a tracking data store and/or a time series database. An application server may further monitor the tracking data store to determine trends such as vehicle components that require maintenance based on the stored tracking data. The example UAV may further include a ring structure that provides a number of benefits including protection of onboard electronics and that provides for different configurations of payload containers and/or power sources. For example, the ring structure of the example UAV allows for a change in dimensions of the payload containers and/or power sources in one or more spatial dimensions.

### Unmanned Aerial Vehicle System:

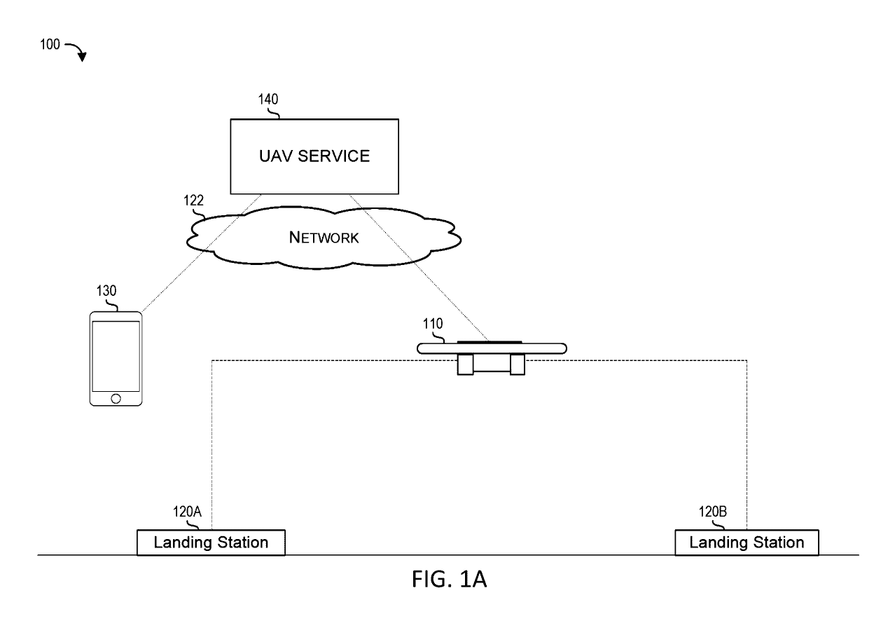

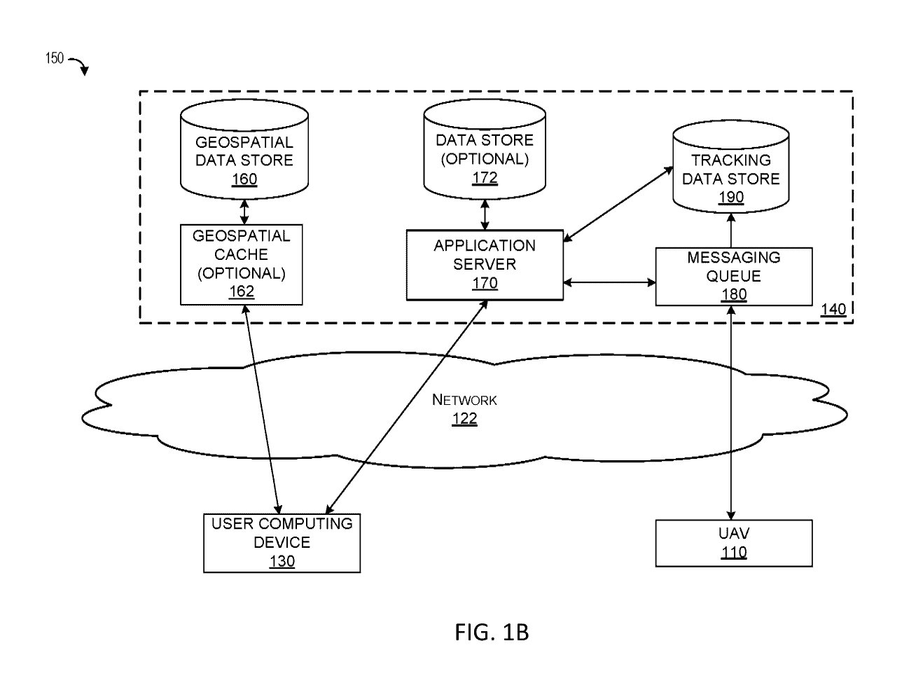

FIG. 1A illustrates an example unmanned aerial vehicle system (“UAV system”), according to some embodiments of the present disclosure. UAV system 100 includes one or more unmanned aerial vehicles 110, landing stations 120A-120B, network 122, user computing device 130, and UAV service 140.

Example UAV system 100 can be used to control and/or navigate UAV 110 to a desired destination. The UAV 110 may be capable of transporting a package from landing station 120A to landing station 120B and/or vice versa. As will be described in further detail herein, user computing device 130 generates a route and instructs UAV 110 to begin its flight via UAV service 140. In some embodiments, a user initiates the flight of the UAV using user computing device 130. In other embodiments, user computing device 130 is optional in UAV system 100 and may not be used. UAV 110 can communicate with UAV service 140 to receive an authorized route and/or transmit data to UAV service 140. UAV 110 can then fly the authorized route. In some embodiments, UAV 110 executes precision landing using an imager and optical markers at the landing station. More information regarding precision landing may be found in U.S. patent application Ser. No. 14/631,789, which is incorporated herein by reference.

In some embodiments, UAV 110 can be configured to communicate wirelessly with UAV service 140. The wireless communication via one or more networks 122 can be any suitable communication medium, including, for example, cellular, packet radio, GSM, GPRS, CDMA, WiFi, satellite, radio, RF, radio modems, ZigBee, XBee, XRF, XTend, Bluetooth, WPAN, line of sight, satellite relay, or any other wireless data link, and/or some combination thereof.

FIG. 1B illustrates another example UAV system, according to some embodiments of the present disclosure. UAV system 150 includes one or more unmanned aerial vehicles 110, network 122, user computing device 130, and UAV service 140. Components of UAV system 150, such as UAV 110, network 122, user computing device 130, and UAV service 140, may be similar to the components of UAV system 100 of FIG. 1A. Example UAV service 140 includes geospatial data store 160, geospatial cache 162, application server 170, application data store 172, messaging queue 180, and tracking data store 190.

An example use of UAV system 150 is when a user selects a starting location and/or selects an unmanned aerial vehicle that is at a particular location from a user interface of user computing device 130. User computing device 130 then requests geospatial data from UAV service 140. UAV service 140 includes geospatial data store 160 and geospatial cache 162. In some embodiments, geospatial data store 160 is an object-relational spatial database that includes latitude and longitude data. Example data and data sources for the geospatial data store 160 include, but are not limited to, terrain data from the National Aeronautics and Space Administration (“NASA”), airspace data from the Federal Aviation Administration (“FAA”), geospatial data from the National Park Service, Department of Defense, and/or other federal agencies, geospatial and/or building data from local agencies such as school districts, and/or some combination thereof. Geospatial data store 160 may include large amounts of data such as hundreds of gigabytes of data or terabytes of data.

In some embodiments, data from geospatial data store 160 is processed and cached into geospatial cache 162. A process may query geospatial data store 160 to cache geospatial data into compressed bundles of data that are indexed by a sector identifier. As used herein, in addition to its ordinary meaning, a “sector identifier” may refer to an identifier used in a geocoordinate reference system. An example sector identifier includes a military grade reference system (“MGRS”) identifier. The compressed geospatial data is indexed by sector identifier and is accessible via geospatial cache 162. In contrast to geospatial data store 160, which may include a client-server database engine, geospatial cache 162 may be embedded into a programming library. For example, the complete database of geospatial cache 162 is implemented within a single file, which is queried by user computing device 130. User computing device 130 requests geospatial data for a particular coordinate in a reference system such as, but not limited to, a latitude and longitude coordinate. User computing device 130 or geospatial cache 162 converts the particular coordinate into the sector identifier and geospatial data is transmitted to user computing device 130 for the sector identifier. In other embodiments, geospatial cache 162 is optional and user computing device 130 communicates directly with geospatial data store 160.

In some embodiments, the geospatial data in geospatial cache 162 has been compressed into memory-efficient data bundles. For example, geospatial cache 162 includes a compressed data package for each sector identifier contains data. Continuing with the example, each compressed data package includes approximately 50 square kilometers. Example techniques that may be used to compress the geospatial data include Lempel-Ziv compression methods, DEFLATE, WavPack, or any lossless data compression technique. In some embodiments, 50 square kilometers of geospatial data are compressed into approximately 2.5 megabytes of data.

In some embodiments, example methods for determining the memory-efficient data bundles and/or geospatial data associated with particular sectors (as defined by a sector identifier) includes starting with a sector within a geographic area and determining geospatial data within a predefined distance from the sector. For example, if a sector is 10 square kilometers then 50 square kilometers around the 10 square kilometers are determined and stored within the memory-efficient data bundles. In some embodiments, a backend process determines memory-efficient data bundles using the previously described process by querying geospatial data store 160 and storing the memory-efficient data bundles in geospatial cache 162.

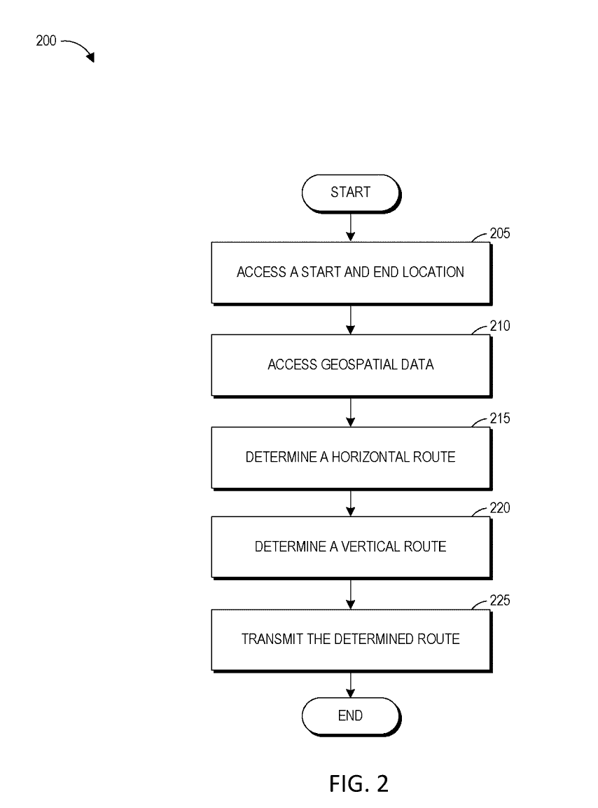

In one example, user computing device 130 determines a navigation route for UAV 110 using the geospatial data received from geospatial cache 162 and/or geospatial data store 160. In other examples, UAV service 140 determines the navigation route, and yet other examples, the route is co-determined based on input and or processing by both computing device 130 and UAV service 140. User computing device 130 and/or UAV service 140 may determine a route for UAV 110 that avoids obstacles and/or no-fly zones, complies with airspace regulations, and/or is energy-efficient. Further detail regarding the route determination algorithm(s) is described with respect to FIGS. 2-5.

User computing device 130 transmits the determined route and/or any UAV instructions to application server 170. Application server 170 authenticates user computing device 130 and/or the user of user computing device 130. In some embodiments, authentication of user computing device 130 occurs via an authentication token. An example authentication token is a shared secret between user computing device 130 and application server 170. Additionally or alternatively, the token includes a timestamp and the timestamp is used to authenticate user computing device 130. Once authenticated and/or authorized example application server 170 stores the determined route and/or UAV instructions in data store 172. Thus, data store 172 may include an audit trail associated with user computing device 130.

Following authentication and/or authorization, application server 170 transmits the route, flight plans, and/or UAV instructions to UAV 110 via the messaging queue 180. Example messaging queue 180 is implemented using a lightweight publish-subscribe messaging protocol. The messaging queue 180 transmits the route, flight plans, and/or UAV instructions to the UAV 110 via network 122. In some embodiments, UAV 110 receives data from messaging queue 180 via a cellular wireless connection.

### Route Planning Processes

FIG. 2 is a flowchart illustrating an example automated route planning process 200, according to some embodiments of the present disclosure. Example process 200 may be performed partially or wholly by user computing device 130 or UAV service 140. For example, route planning can be performed by any of the systems or processors described herein, such as UAV service 140 and/or application server 170, and/or some combination thereof. As previously mentioned, user computing device may initiate route planning process 200 in response to user interaction with user computing device 130. Depending on the embodiment, process 200 may include fewer or additional blocks, the blocks may be performed in an order different than is illustrated, and/or some blocks may be performed partially or wholly in parallel (e.g., determining a horizontal and vertical route may be performed at least partially in parallel).

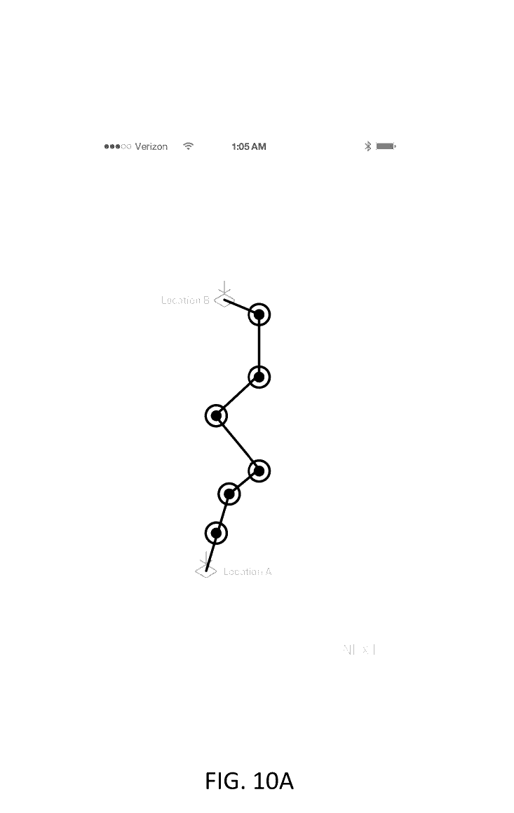

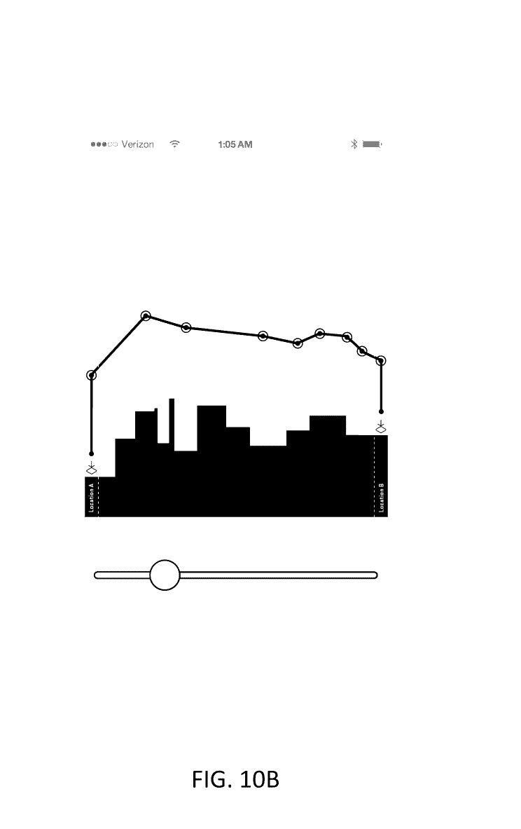

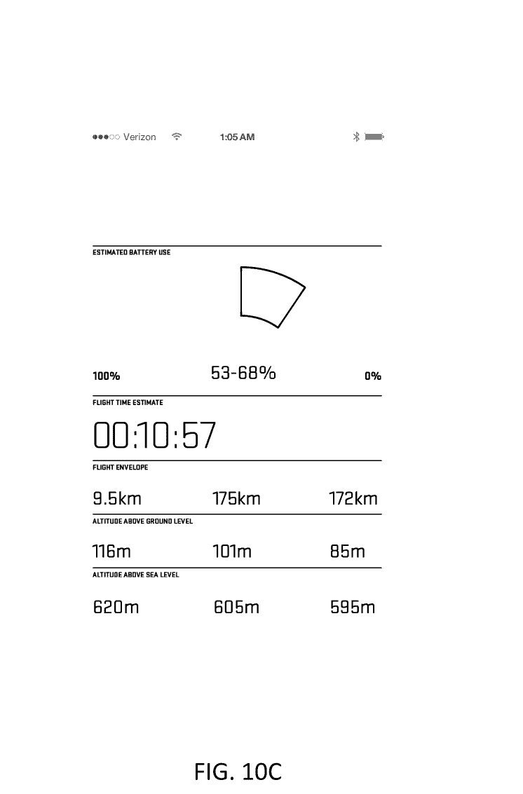

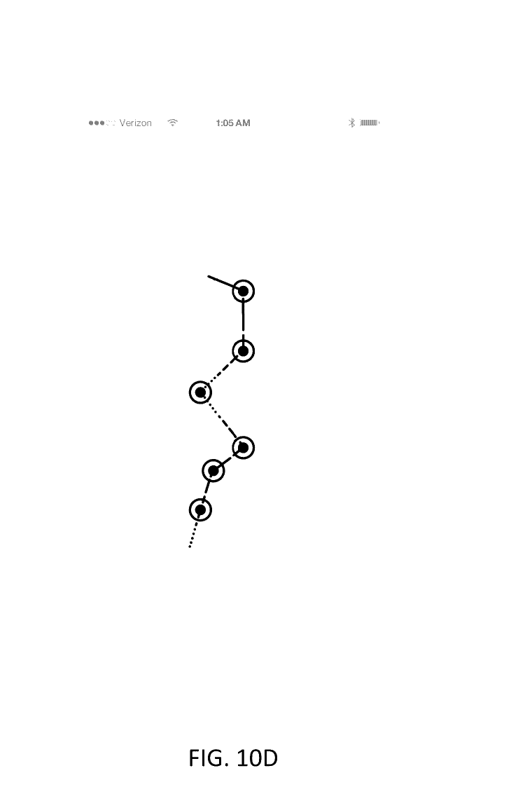

Beginning at block 205, user computing device 130 accesses a start and end location. The start and end location may be specified by user input. In some embodiments, a user may select a start landing station and an end landing station within a user interface. Example user interface selections are illustrated by FIGS. 10A-10D. Additionally or alternatively, a user may specify the start and end location in a variety of manners, including selecting two points on a map within a user interface, selecting from pull-down menus of locations (e.g., business names, addresses, and the like). The start and end location data includes coordinates on a reference system. Example coordinates and reference systems include, but are not limited to, latitude and longitude coordinates or Universal Transverse Mercator (“UTM”) coordinates.

At block 210, user computing device 130 accesses geospatial data from UAV service 140. As shown, in some embodiments, geospatial data is accessed after block 205. User computing device 130 requests geospatial data based on the start location. For example, user computing device 130 converts the start location into a sector identifier and requests geospatial data from geospatial cache 162 for the sector identifier, as described herein. In another example, UAV service 140 and/or geospatial cache 162 converts the start location into a sector identifier and transmits the corresponding geospatial data for the sector identifier, as described herein. In other embodiments, geospatial data may be accessed before block 205. For example, as shown in FIG. 10A, a user may select a geographic area (e.g., by entering a city or address, or opening a map which leverages a current location of the user), which may cause user computing device 130 to access and/or download geospatial data from geospatial cache 162. Additionally or alternatively, downloaded geospatial data is locally stored and/or cached on user computing device 130 such that the user computing device 130 may use a local copy of geospatial data without requesting it from UAV service 140. In some embodiments, local copies of the geospatial data may be refreshed and/or re-downloaded from UAV service 140 periodically and/or in response to a message from UAV service 140 to refresh and/or based on user input to refresh.

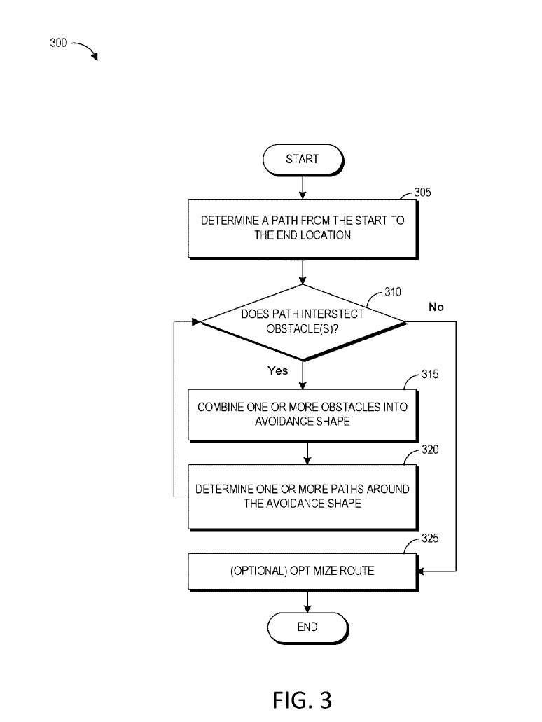

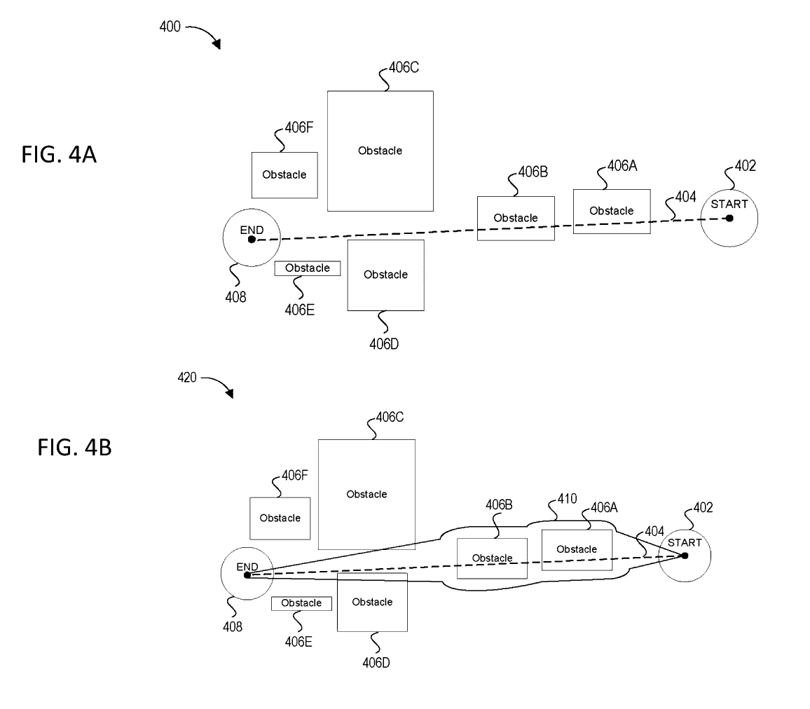

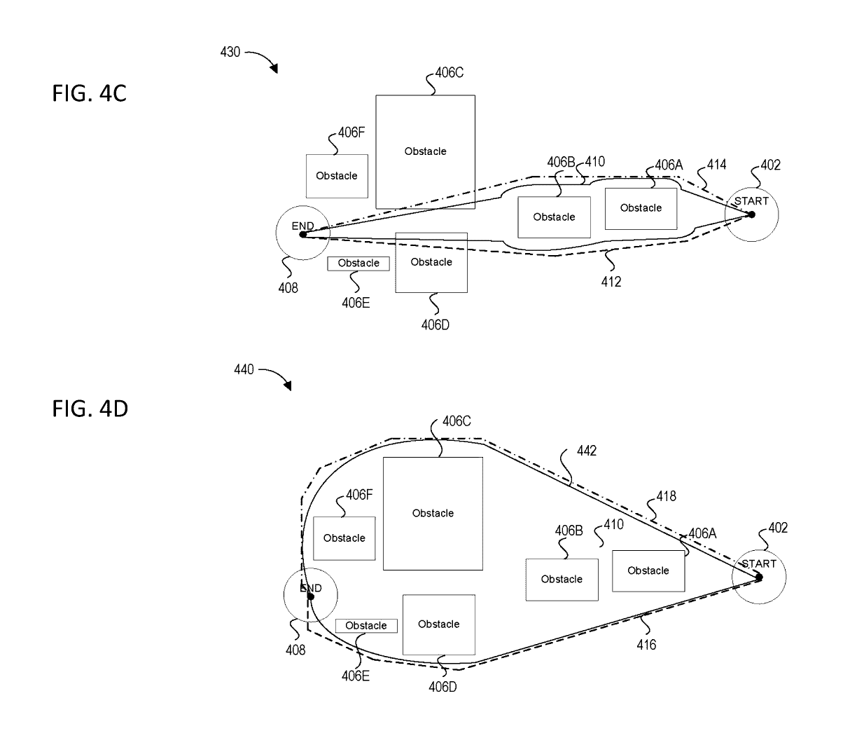

At block 215, user computing device 130 determines a horizontal route from the start location to the end location. User computing device 130 determines a horizontal route that avoids obstacles. In some embodiments, geospatial data from geospatial data store 160 may include classifications of obstacles. Example obstacle classifications include a critical avoidance zone and a general avoidance zone. Critical avoidance zones may include areas such as military installations, FAA controlled airspace, and/or national parks. The UAV system and/or using computing device 130 may generate routes that avoid critical zones. General avoidance zones may include geospatial data associated with schools, buildings, or any predefined areas that are to be generally avoided in routes but are permissible as start and end locations. For example, geographic areas are classified as general avoidance zones where the geospatial data indicates that an object (such as a building) within the geographic area is above a predefined height such as 30 m, 40 m, or 50 m, etc. Thus, user computing device 130 may permit a route to start and/or end at a building and/or school but the route otherwise does not intersect general avoidance zones, such as buildings and/or schools between the start and end locations. A user interface may include overlay schemes (e.g., color schemes, icons, etc.) to identify general avoidance zones and critical avoidance zones. Horizontal route determination is described in further detail with respect to FIGS. 3 and 4.

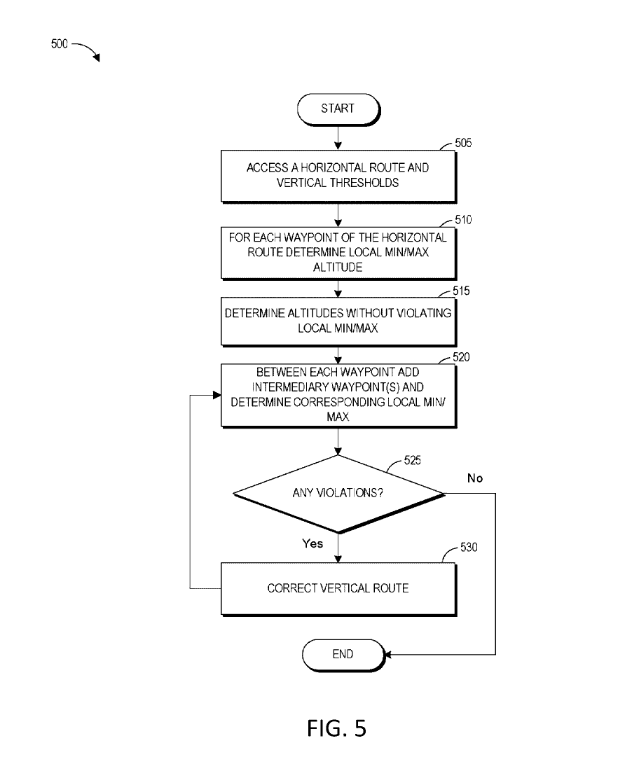

At block 220, user computing device 130 determines a vertical route based on the determined horizontal route. For example, airspace regulations and/or flight safety practices establish recommended minimum and/or maximum altitudes that a UAV should fly at relative to the ground. Moreover, a change in altitude may consume energy such that a preferred vertical route achieves the highest altitude without subsequently having to decrease in altitude with respect to waypoints and/or the destination of the route. In some embodiments, user computing device 130 determines the vertical route following a horizontal route determination, which may prioritize horizontal route planning over vertical route planning. Vertical route determination is described in further detail with respect to FIG. 5 (and FIG. 10B).

At block 225, user computing device 130 transmits the determined route to UAV service 140. For example, user computing device 130 combines the horizontal and vertical routes into a combined route that is usable by UAV 110. An example combined route includes a series of coordinates such as latitude, longitude, and altitude values. In the example, user computing device 130 transmits the combined route to application server 170 via network 122. The route is transmitted to UAV 110 via the messaging queue 180. UAV 110 then executes the route UAV 110 upon receiving instructions to begin the route.

FIG. 3 is a flowchart illustrating an example horizontal route planning process 300, according to some embodiments of the present disclosure. Example process 300 may be performed by user computing device 130. Similar to the route planning of example process 200, horizontal route planning can be performed by any of the systems or processors described herein, such as UAV service 140 and/or application server 170, and/or some combination thereof. Depending on the embodiment, process 300 may include fewer or additional blocks and/or the blocks may be performed in an order different than is illustrated.

At block 305, user computing device 130 determines a path from the start location to the end location. In some embodiments, user computing device executes preliminary steps before block 305. Example preliminary steps include accessing the start and end location, and accessing geospatial data such as blocks 205 and 210 of process 200, respectively. As determined by user computing device 130, an example path from the start the end location includes a straight line from the start to the end location. An example straight-line path is illustrated by FIG. 4A.

At block 310, user computing device 130 determines whether the path at block 305 intersects any obstacles. Example intersection of obstacles by the determined path of block 305 is illustrated with respect to FIG. 4A. As illustrated in FIG. 4A, path 404 intersects two obstacles 406A and 406B. Thus, user computing device 130 proceeds to block 315 if the past intersects one or more obstacles. Otherwise, user computing device 130 proceeds to block 325. In some embodiments, the accessed geospatial data is queryable by user computing device 130 to determine whether any obstacles intersect the determined path.

At block 315, user computing device 130 combines the intersected one or more obstacles into an avoidance shape. An example method for combining two or more obstacle polygons into an avoidance shape, as used by a user computing device 130, is a convex hull. A shape is convex if for any two points that are part of the shape the connecting line between any two points is also a part of the shape. Example convex hull algorithms include a giftwrapping approach and/or Jarvis March, a Graham scan, Quickhull, Divide and Conquer, Monotone Chain and/or Andrews algorithm, mental convex hull algorithm, a planar convex hull algorithm, Chan's algorithm, or any other algorithm for determining a convex shape. Example avoidance shapes generated by user computing device 130 using a convex hull algorithm are illustrated by FIGS. 4B-4D. For example, avoidance shape 410 of FIG. 4B is a convex hull that does not have any intersecting points between points from obstacles 406A and 406B, start location 402, and end location 408. In some embodiments, user computing device 130 calculates a predefined distance from the obstacles within the convex hull to generate the avoidance shape. Example predefined distances surrounding an obstacle include 40 m, 50 m, etc., which may be configurable in some embodiments. Thus, example avoidance shapes include elliptical portions as determined by the predefined distances surrounding obstacles within the convex hull. Example avoidance shapes that include elliptical portions are illustrated by FIGS. 4B-4D.

At block 320, user computing device 130 determines one or more paths around the avoidance shape. For example, user computing device chooses one or more directions towards the end location and traverses around the avoidance shape without touching the avoidance shape. Example methods for choosing paths around the avoidance shape include proceeding left or right, or up or down from the starting location depending on the particular orientation relative to a point within the reference system. For example, FIG. 4C illustrates a left path 412 and a right path 414 around avoidance shape 410 to end location 408. User computing device 130 then returns to block 310 to determine whether any of the generated paths intersect additional obstacles. For example, as illustrated by FIG. 4C, left path 412 intersects obstacle 406D and right path or intersects obstacle 406C. Thus, user computing device 130 continues repeating blocks 310, 315, and 320 to recursively grow the avoidance shape and determine one or more paths around the avoidance shape until a path does not intersect an obstacle. In some embodiments, where there are more than one viable paths to the end location that do not intersect an obstacle, user computing device 130 selects a route from the viable paths that is the shortest distance and/or contains the least number of vertices. For example, user computing device 130 selects path 416 as the horizontal route because path 416 is shorter and/or has less vertices than path 418. User computing device then proceeds to block 325 because a route has been determined that does not intersect an obstacle.

At block 325, user computing device 130 optimizes the route. Example route optimizations performed by user computing device 130 iterate through vertices within the route. For example, once a vertex is removed from the route, user computing device 130 determines whether the new route (without the vertex) intersects any obstacles. In some embodiments, a binary search algorithm is used to select a vertex (such as choosing a vertex approximately at a middle distance in the route) and remove the vertex if it does not intersect an obstacle. In other embodiments, user computing device 130 iterates through the vertices of the route in a linear order to further optimize the route, such as by removing the vertex and determining whether the removal causes the updated path to intersect an obstacle.

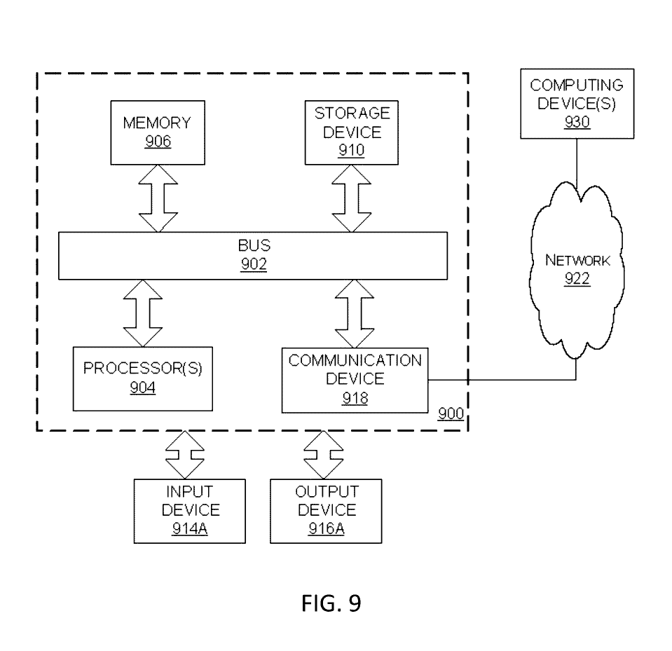

In some embodiments, the determined route is stored in non-transitory computer storage. For example, user computing device 130 stores the determined route in data storage of user computing device 130 such as data storage device 910 of FIG. 9. Additionally or alternatively, the determined route is stored in non-transitory computer storage of the UAV and/or UAV service 140 following transmission of the determined route.

FIGS. 4A-4D are example diagrams illustrating a horizontal route determination process, according to some embodiments of the present disclosure. Example diagram 400 of FIG. 4A includes start location 402, obstacles 406A-F, a path 404, and end location 408. Diagram 400 and/or data corresponding to diagram 400 may be generated by process 300 of FIG. 3 such as block 305. Example diagram 420 of FIG. 4B may be similar to example diagram 400 in many aspects. However, one difference between diagram 420 and example diagram 400 is that diagram 420 includes avoidance shape 410. User computing device 120 may generate avoidance shape 410 using process 300 of FIG. 3 such as block 315. Example diagram 430 of FIG. 4C may be similar to example diagram 420 in many aspects. However, one difference between example diagram 430 and example diagram 420 is that diagram 430 includes first path 412 and second path 414. User computing device 130 may generate the first and second paths 412 and 414 using process 300 of FIG. 3 such as block 320. Example diagram 440 of FIG. 4D may be similar to example diagram 430 in many aspects. However, differences between example diagram 440 and example diagram 430 is that diagram 440 includes avoidance shape 442 and third and fourth paths 416 and 418, respectively. User computing device 120 may generate avoidance shape 442 and the third and fourth paths 416 and 418 using process 300 of FIG. 3 such as block 310, 315, and/or 320. Moreover, in the example, user computing device executes multiple iterations of blocks 310, 315, and 320 to generate shape 442 and paths 416 and 418.

In some embodiments, user computing device 130 may present a user interface similar to the example diagrams of FIGS. 4A-4D. For example, during and/or after execution of process 300 of FIG. 3, user computing device 130 may cause presentation of a user interface illustrating the route determination process. In some embodiments, while executing process 300, user computing device 130 may generate hundreds or thousands of avoidance shapes and/or paths. However, in the example, user computing device 130 causes presentation of a subset of those avoiding shapes and/or paths in a user interface. For example, user computing device 130 presents a predefined number of iterations, such as five, six, or ten iterations, corresponding to process 300 (including the final iteration). Example user interface representation of a horizontal route determination process are illustrated in FIG. 10A.

An aspect of a user interface representation of a route includes a visualization of energy and/or power status of the UAV. For example, FIG. 10D illustrates a color gradient of the route that indicates estimated or actual energy, battery, and/or power status of the UAV. For example, one color (such as green) indicates relatively lower energy status of the UAV, another color (such as red) indicates a relatively higher energy status, and color gradients in between the two or more colors further indicates relative energy status.

FIG. 5 is a flowchart illustrating an example vertical route planning process, according to some embodiments of the present disclosure. Example method 500 may be performed by user computing device 130. Similar to the route planning of example process 200, vertical route planning can be performed by any of the systems or processors described herein, such as UAV service 140 and/or application server 170, and/or some combination thereof. Depending on the embodiment, method 500 may include fewer or additional blocks and/or the blocks may be performed in an order different than is illustrated.

At block 505, user computing device 130 accesses a horizontal route and vertical thresholds. For example, user computing device 130 accesses the horizontal route generated by example process 300 of FIG. 3. In some embodiments, user computing device 130 accesses geospatial data similar to the data access of block 210 of FIG. 2. Continuing with the example, user computing device 130 further accesses vertical thresholds associated with the geospatial data and/or the particular geographic area of the route. Example vertical thresholds include preferred minimum altitudes for a UAV to fly, such as at least 50 m or 100 m above ground level, or maximum altitudes, such as applicable regulations that specify a particular altitude that a UAV or aircraft must fly above ground level (e.g., 121 m above ground level). In some embodiments, vertical thresholds are accessed within the geospatial data and/or receive from UAV service 140. In some embodiments, flight above a minimum altitude may be preferred to reduce the probability that a UAV will encounter trees, buildings, or any other obstacles.

At block 510, user computing device 130 determines local minimum and maximum altitudes for one or more waypoints of the accessed horizontal route. For example, user computing device 130 selects the vertices of a horizontal route to be waypoints. Example route 416 of FIG. 4D illustrates vertices that may be selected as waypoints of a vertical route. Continuing with the example, user computing device determines local minimum and maximum altitudes for the waypoints of route. Local minimum and maximum altitudes may change at each waypoint of the route because the respective ground level of each waypoint may change. One particular example is as follows: waypoints A, B, and C have ground elevation of 0 m, 10 m, and 30 m. Continuing with the example, local minimum and maximum altitudes for waypoints A, B, and C are 50 m/121 m, 60 m/131 m, and 80 m/151 m, respectively.

At block 515, user computing device 130 determines particular altitudes for the one or more waypoints based on the local minimum and maximum altitudes. In some embodiments, it may be preferred to select altitudes of a route at the highest altitude within the maximum local altitude without subsequently having to reduce altitude (such as a descent required for landing). Advantages of selecting higher altitudes without subsequently reducing altitude is that altitude changes may consume more energy than constant altitude flight and/or may reduce the likelihood of encountering obstacles.

At block 520, user computing device 130 adds intermediary waypoints between each waypoint and determines corresponding local minimum and maximum altitudes for the intermediary waypoints. Geographic terrain, such as the ground-level, can change. Thus, in the example, user computing device 130 verifies that altitudes in between the waypoints do not violate the vertical thresholds. For example, if waypoint A is 200 m from waypoint B, user computing device checks intermediary waypoints between waypoints A and B because the ground-level may change. User computing device 130 adds intermediary waypoints based on a predefined distance between the waypoints of the horizontal route. In some embodiments, the predefined distance for intermediary waypoints are 30 m, 40 m, or 50 m, etc. In the example, user computing device 130 determines corresponding local minimum and maximum altitudes for the intermediary waypoints.

At block 525, user computing device 130 determines whether there are any violations of the vertical route. For example, user computing device 130 analyzes the initial vertical route determined at block 515 using the intermediary waypoints and corresponding minimum and maximum altitudes determined at block 520. Continuing with the example, the initial vertical route determined at block 515 is compared against the local minimum and maximum altitudes of the intermediary waypoints. For example, an altitude of 150 m would violate a local maximum vertical threshold of 100 m, and an altitude of 60 m would violate a local minimum vertical thresholds of 70 m. If there are violations user computing device 130 proceeds to block 530 to correct the violations.

At block 530, user computing device 130 corrects the violation. User computing device 130 corrects the vertical route by taking two waypoints (such as the waypoints determined at block 510) and determines a maximum violation between the two waypoints using the intermediary waypoints of block 520. For example, if there are two violations corresponding to intermediary waypoints E and F between waypoints A and B, then user computing device 130 selects the violation that is the absolute greater violation from the respective vertical threshold. Then, if the selected violation is a local maximum violation, user computing device 130 updates to vertical route to be below the local maximum vertical threshold. Conversely, if the selected violation is a local minimum violation, user computing device 130 updates the vertical route to be above and/or to the floor of the local minimum vertical threshold. Continuing with the example, assume that the violation at intermediary waypoint E was the maximum violation. In the example, once user computing device 130 updates the vertical route, the segment is broken at the maximum violation waypoint (such as intermediary waypoint E) and the resulting two segments are processed again by blocks 520, 525, and 530 until there are no more violations in a recursive manner.

FIG. 10B illustrates a diagram of an example route generated by method 500 of FIG. 5. For example, FIG. 10B illustrates a determined vertical route where the route attempts to reduce the rate of change in altitude along the route, while remaining within the maximum and minimum altitudes desired. In some examples, the route may obtain the highest (or lowest) altitude within the maximum (or minimum) local altitude without subsequently having to reduce (or gain) altitude (until landing). In some embodiments, vertical route visualizations are presented to the user. For example, a user may be presented with a vertical route for their first operation of a UAV and then subsequent operations of a UAV via the user interface may not present the vertical route and/or presentation route may be configurable by a user.

### Unmanned Aerial Vehicle

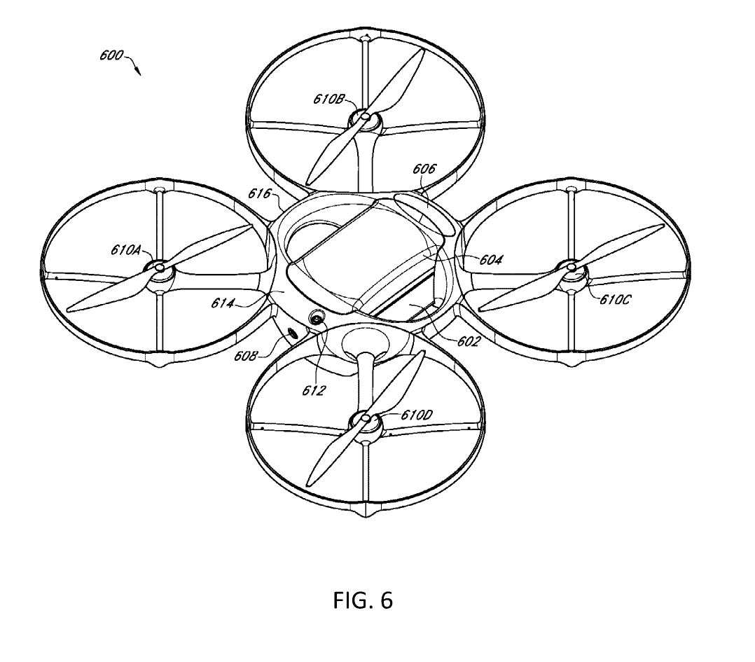

FIG. 6 illustrates an example unmanned aerial vehicle, according to some embodiments of the present disclosure. Example UAV 600 includes a payload container 602, a power source 604, a rear portion area 606, imager 608, motors 610A-610D, an on-off button 612, and a front portion area 614. Depending on the embodiment, UAV 600 may include fewer or additional components than is illustrated. Example materials used for the construction of UAV 600 include carbon fiber, carbon filled nylon, and/or plastic materials.

As illustrated, UAV 600 includes a central ring. The ring of example UAV 600 enables a rigid structure that incorporates and protects all the electronic and/or avionic components inside it. Placement of the electronic and/or avionic components inside the center ring allows protection from the weather and other elements. As illustrated, the payload container 602 and power source 604 are configured within the center ring that allows maximum protection by the ring structure. Moreover, the open inner area of UAV 600 allows top loading of payload container 602 and power source 604. In some embodiments, UAV 600 may allow bottom loading and/or releasing of payload container 602 and/or power source 604. Power source 604 may be secured to the UAV using a locking mechanism that also secures payload container 602. Another advantage of the open inner area and the ring structure of UAV 600 is that side handles may be used for carrying of the UAV 600 while not in flight. The ring of example UAV 600 narrows down in two opposite sides and thus incorporates handles as part of its structure. For example, handle area 616 of UAV 600 may be used for carrying of UAV 600 by a human.

In some embodiments, payload container 602 is above power source 604 within the open inner area of the UAV (not illustrated). Additionally or alternatively, payload container 602 and power source 604 are interchangeable within the open inner area of the UAV. For example, the same UAV may permit payload container 602 to be placed above power source 604 and vice versa.

In some embodiments, particular electronic and/or avionic components are housed within different sections of the center portion of UAV 600. For example, a global positioning receiver may be placed in the rear portion area 606 and other electronic components, such as an application processor, are placed in the front area portion 614 to avoid interfering with the reception of the global positioning receiver.

In some embodiments, the frame of example UAV 600 is constructed using a bird bone internal structure that is made out of multiple small ribs. An internal tube runs through the example UAV, with the bird bone structure, for wiring. The example bird bone structure may be created using additive manufacturing.

Example UAV 600 may be modular. Components of example UAV 600 such as the propeller guards in the arm struts may be removable to reduce the weight of UAV 600 and increase its flight performance.

As illustrated in FIG. 6, imager 608 is front facing. Example UAV 600 may also include a bottom facing imager (not illustrated in FIG. 6). In some embodiments, the bottom facing imager is used for precision landing. More information regarding precision landing may be found in U.S. patent application Ser. No. 14/631,789, which is incorporated herein by reference.

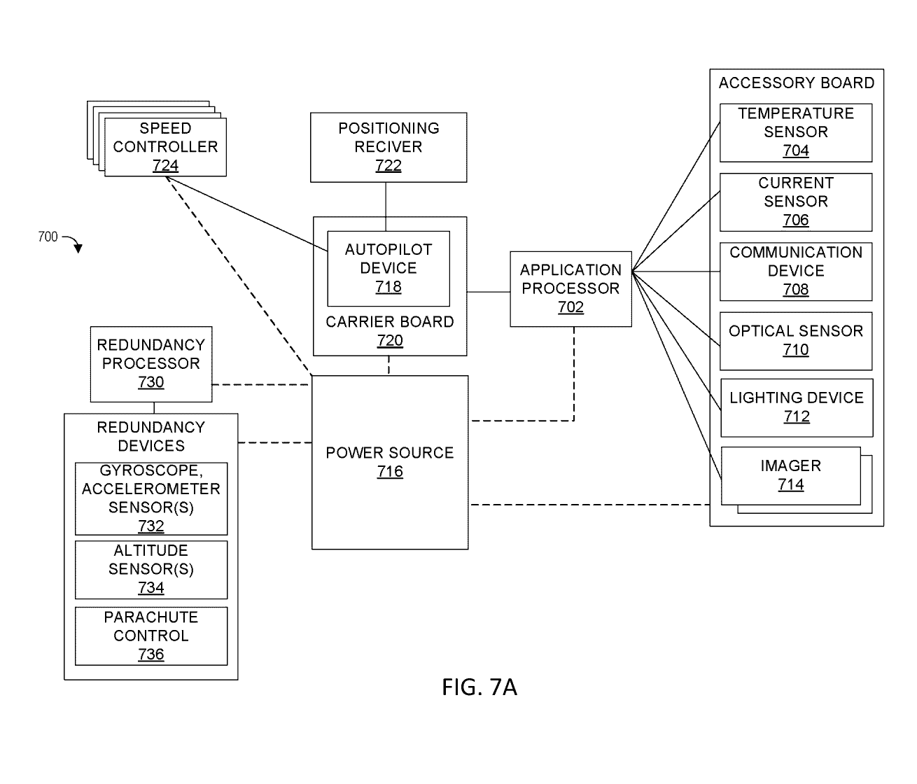

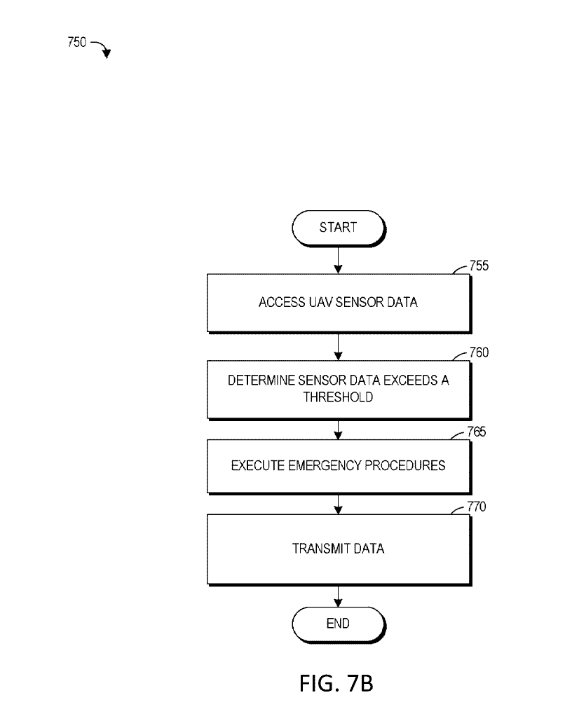

FIG. 7A is a diagram illustrating an example computing system of an unmanned aerial vehicle, according to some embodiments of the present disclosure. Example UAV computing system 700 includes application processor 702, power source 716, carrier board 720, autopilot device 718, positioning receiver 722, and speed controllers 724. The example UAV computing system 700 is included within the example UAV 600. For example, the application processor 702, autopilot device 718, and other components of UAV computing system are housed within front area portion 614 of UAV 600. Some components of UAV computing system 700 are shown in FIG. 6. For example, power source 716 may correspond to power source 604.

Example UAV computing system 700 includes communication device 708. Communication device 708 provides a two-way data communication to a network. For example, communication device 708 sends and receives electrical, electromagnetic, or optical signals that carry digital data streams representing various types of information via cellular, packet radio, GSM, GPRS, CDMA, WiFi, satellite, radio, RF, radio modems, ZigBee, XBee, XRF, XTend, Bluetooth, WPAN, line of sight, satellite relay, or any other wireless data link. An example communication device 708 is a 3G/4G cellular modem. Example communication device 708 receives data from messaging queue 180 via network 122 of FIG. 1B. Example received data includes generated routes from user computing device 130 and instructions from user computing device 130 and/or application server 170.

Application processor 702 such as a hardware processor may process data received via a communication device 708. For example, application processor 702 transmits navigation instructions to autopilot device 718. Autopilot device 718 receives positioning data from positioning receiver 722. Positioning data may be in a global positioning format and/or Global Positioning System (GPS) format. Autopilot device 718 can navigate the UAV and/or cause speed controller 724 to update using instructions from application processor 702 and the positioning data. In some embodiments, the route data includes sufficient information for UAV computing system 700 to complete the loaded mission even if computing system 700 loses cellular connectivity during flight.

In some embodiments, carrier board 720 is a customized for autopilot device 718. For example, ports from carrier board 720 may be customized to connect to ports from autopilot device 718 and carrier board 720 may include interface to connect to application processor 702. In some embodiments, carrier board 720 operates over a wide voltage input range. For example, a customized carrier board 720 may operate between 7 V to 40 V, which may allow autopilot device 718 to be compatible with higher voltage power sources.

Example embodiments of power source 716 include lithium ion batteries, lithium polymer batteries, or any other source of energy. In some embodiments, a lithium polymer battery is constructed to fit within the casing of UAV 600. Some embodiments may use lithium ion batteries as power source 716 for better power density than the power density of an alternative battery, such as a lithium polymer battery. In some embodiments, power source 716 includes a battery manager. A battery manager enables a battery embodiment of power source 716 to operate within a safe voltage range, monitoring its state, calculating secondary data, report data, controlling the battery environment, and/or balancing the energy cells of the battery.

Example application processor 702 receives data from propulsion monitors including temperature sensor 704 and current sensor 706. In the example computing system 700, temperature sensors 704 are connected to speed controllers 724 to monitor the respective temperatures of the speed controllers. In some embodiments, application processor 702 executes software instructions to monitor the temperature of the speed controllers. Additionally or alternatively, application processor 702 may execute emergency instructions, such as causing the UAV to land or slowing speed controllers 724 down, if the temperature data exceeds particular thresholds. An example threshold would be if the speed controller temperature exceeds a first threshold, such as 85° C., then the speed controller would be instructed to draw less power from power source 716 and/or to reduce the speed of one or more speed controllers. A second threshold, such as a temperature above 85° C., may cause application processor 702 to initiate further emergency procedures such as landing. In yet other embodiments, sensor data is transmitted to user computer device 130 for presentation of the sensor data or visualization of the sensor data in a user interface. Similar to the collection and monitoring of temperature data by application processor 702, application processor 702 collects and monitors motor current sensor data from the UAV. For example, application processor 702 may initiate a preflight test to spin the propellers and to determine that the propellers are drawing sufficient power from the motors using sensor data from current sensor 706. In some embodiments, similar to the emergency procedures executed by application processor 702, application processor 702 can execute emergency procedures based at least on the current sensor data. For example, application processor 702 reduces the power being drawn from the motors or initiates landing if the current sensor data exceeds first and second thresholds, respectively.

In some embodiments, application processor 702 transmits UAV location data, pitch heading data, temperature sensor data, motor current sensor data, energy data, positional data, and/or any other collected data to UAV service 140. For example, temperature data of the UAV that is sent to you UAV service 140 is stored in tracking data store 190. Example application processor 702 transmits data to UAV service 140 in near time. Thus, application processor 702 is able to report status data such as temperature, energy usage, and/or telemetry, during flight to UAV service 140. In some embodiments, application processor reports status data to UAV service 140 based on a predefined configurable interval such as every second or four times per second.

In some embodiments, UAV service 140 may analyze data stored in tracking data store 190 for trends. For example, trend data that a particular speed controller and/or motor is consistently running hotter than other speed controllers and/or motors (on the same UAV or compared to other UAVs in the system) may indicate that the particular speed controller and/or motor should be replaced or repaired. Thus, analysis of tracking data within tracking data store 190 may be used for preventative maintenance by identifying outliers within the tracking data.

Example application processor 702 further receives data from optical sensors 710. Example optical sensors 710 can include a light radar (LIDAR) device that measures distance by illuminating a target with a laser and analyzing the reflected light. For example, optical sensors 710 can detect an obstacle in the path of UAV and application processor 702 may initiate object avoidance procedures. Additionally or alternatively, application processor 702 can instruct UAV to pause in midair and capture an image of the obstacle to transmit the image to UAV service 140, which may be reviewed by a user in user computing device 130. For example, user computing device 130 may provide a user interface for a user to transmit further instructions such as going around the obstacle or to terminate the mission and return home or to a new destination. For example, an additional route may be determined using example process 200 of FIG. 2 while a UAV is in flight. In some embodiments, if application processor 702 does not receive further instructions from user computing device 130 application processor 702 instructs UAV to return home or to land nearby.

Example application processor 702 further receives data from one or more imagers 714. Imager 714 can be a number of different devices including, without limitation, a camera, imaging array, machine vision, a video camera, image sensor, charged-coupled device (CCD), a complementary metal oxide silicon (CMOS) camera, etc., or any similar device. The imager can be greyscale, color, infrared, ultraviolet, or other suitable configuration. Similar to the optical sensor 710 an imager 714 may be used for obstacle detection and/or avoidance. The UAV may include a front facing imager for obstacle avoidance. Additionally or alternatively, an imager may be placed on the bottom of the UAV for precision landing. More information regarding precision landing may be found in U.S. patent application Ser. No. 14/631,789.

Example application processor 702 can cause illumination via one or more lighting devices 712. Example lighting devices 712 may include light emitting diodes (LED) or high intensity light emitting diodes. UAV 600 may include one or more lighting devices 712. For example, lighting devices 712 can be on the top and/or bottom portions of UAV 600 (not illustrated in FIG. 6). In some embodiments, lighting device 712 may indicate a status of the UAV. For example, different colors and/or pulse frequencies of an LED lighting device 712 may indicate different statuses of the UAV to a user and/or operator such as the status of cellular and/or Internet connectivity, connection to the autopilot device, or any message to be conveyed to a user. In some embodiments, a bottom facing lighting device may be used for ground illumination and/or precision landing, which is described in further detail in U.S. patent application Ser. No. 14/631,789.

### Redundancy System of Unmanned Aerial Vehicle

Example computing system 700 further includes redundancy processor 730 and redundancy devices such as a gyroscope, accelerometer, magnetometer, or other inertial navigation sensors 732, altitude sensor 734, and parachute control 736. By further including redundancy devices and a redundancy processor 730 that are independent of other devices of computing system 700 the UAV may further detect and/or initiate emergency procedures such as the deployment of one or more parachutes via parachute control 736. For example, redundancy processor 730 can detect indicators that UAV should initiate an emergency procedure. Example indicators include, but are not limited to, a change in pitch, acceleration, altitude, and/or some combination thereof that triggers an emergency condition. For example, if the UAV is a falling at a speed higher than a trigger threshold then redundancy processor 730 may deploy the parachute. In some embodiments, the redundancy system is designed with double, triple, or any number of redundancy mechanisms and a voting system to determine if the parachute should deploy and/or where to execute any other emergency procedures. An example triple redundancy system is as follows: if one of three indicators is beyond a threshold, such as an indicator that the vehicle is falling at a speed higher than a trigger threshold, and the other two indicators are showing lower speed, the redundancy system will avoid a false positive and not trigger. In response to a detection of an emergency situation, example redundancy processor 730 stops power to the motors and/or speed controllers of the UAV and deploys the one or more parachutes of the UAV. A redundancy system as illustrated may be an important piece of safety equipment to ensure that if there is a hardware and/or software failure the redundancy system can limit the danger to the vehicle itself and for people and/or things below.

### Emergency Process

FIG. 7B is a flowchart illustrating an example emergency process for controlling an unmanned aerial vehicle, according to some embodiments of the present disclosure. Example method 750 may be performed by application processor 702, autopilot device 718, redundancy processor 730, and/or some combination thereof. Emergency method 750 can be performed by any of the systems or processors described herein. Depending on the embodiment, method 750 may include fewer or additional blocks and/or the blocks may be performed in an order different than is illustrated.

At block 755, application processor 702 accesses UAV sensor data. Example UAV sensor data includes temperature, current, optical, and/or telemetry data, as described herein.

At block 760, application processor 702 determines whether the UAV sensor data exceeds one or more thresholds. Example thresholds includes one or more values that indicate that application processor 702 should proceed to block 775. For example, if temperature sensor data is above a first value such as 85° C., then application processor 702 proceeds to an emergency procedure. In other embodiments, if the temperature sensor data is above the second value such as 90° C. then application processor 702 proceeds to a different emergency procedure. Additional example thresholds include a pitch angle and/or acceleration value that indicate that redundancy measures should be executed such as the deployment of one or more parachutes.

At block 765, application processor 702 executes one or more emergency procedures. Example emergency procedures include slowing one or more speed controllers and/or landing. In some embodiments, such as embodiments that detect obstacles via optical recognition, the emergency procedure may include holding the UAV at a particular location during flight to wait for further instructions. As described herein, other emergency procedures include deployment of one or more parachutes and/or stopping of speed controllers.

At block 770, application processor 702 optionally transmits data to UAV service 140, as described in detail herein. For example, sensor data is transmitted for storage in tracking data store 190. As described herein, tracking data in tracking data store 190 may be used by UAV service 140 for predictive maintenance and/or determining trends from the tracking data. In some embodiments, application processor 702 transmits data indicating that one or more emergency procedures have been executed, such as landing, slowing, or the deployment of a parachute.

Configurable Payload Containers and/or Power Sources

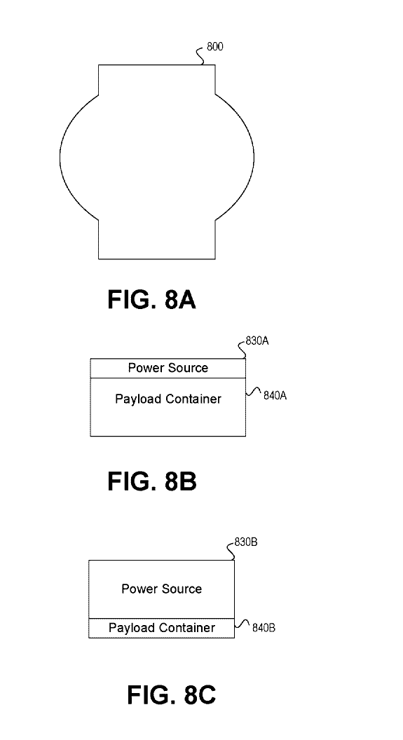

FIGS. 8A-8C illustrate example diagrams of configurable payload containers and/or power sources. The structure of some UAV embodiments disclosed herein permits configurable payload containers and/or power sources. FIG. 8A illustrates a top view of an example payload container 800. As illustrated, example payload container 800 is larger than payload container 602 of FIG. 6. Example payload container 800 includes elliptical sides that increase the payload size within the container. Moreover, payload container 800 fits within the open inner area of UAV 600 (because the shape of the elliptical sides of payload container 800 also fit within the open inner area of UAV 600). UAV 600 can be compatible with both containers 602 and 800.

FIGS. 8B and 8C illustrate example configurations of different power source dimensions and payload container dimensions. As illustrated in FIG. 8B, a payload container 840A can be paired with and be relatively larger than a power source 830A to fit within UAV 600. Conversely, as illustrated in FIG. 8C, a payload container 840B can be paired with and be relatively smaller than power source 830B. Various combinations of power sources and payload containers, such as power sources and payload containers 830A/840A and 830B/840B, can be compatible with the same UAV 600. Thus, the design of UAV 600 may permit configurable power source and payload container configurations such that particular missions for smaller payloads may have a UAV has a greater travel radius due to the larger power source. Conversely, larger payloads may be transported in shorter distances due to a smaller power source. Other embodiments of power source and payload container configurations are included in the present disclosure other than those illustrated in FIGS. 8B and 8C, such as a power source and payload container that are of equal height.

In some embodiments, the payload container itself directly interfaces with the power source. For example, a powered payload container can refrigerate the contents of the payload container. Refrigeration of payloads may be useful for medical transportation purposes. Another example of a powered payload container may be a heated payload container. Moreover, UAV 600 may include a heater device to heat the power source (such as a battery), which may be advantages in freezing and/or cold weather flight conditions.

In some embodiments, the power source and/or payload container are locked into place using a solenoid device. Authentication to open the solenoid may occur via a user computing device or a thumbprint recognition device on the UAV. Additionally or alternatively, the power source and/or payload container may have a key locking mechanism to remove the power source and/or payload.

While the present disclosure often discusses unmanned aerial vehicles in the context of the transportation of goods, some of the systems, methods, and vehicles described herein may be used for other purposes and/or contexts. For example, the route planning methods described herein may be used for recreational flight of a UAV, for monitoring purposes by a UAV, and/or agricultural purposes such as crop inspection by a UAV. While the present disclosure often discusses a UAV with a payload container, it will be appreciated that the payload container can be replaced with another component such as electronic devices and/or a sensor suite. For example in UAV 600 of FIG. 6, container 602 can be a sensor suite. The electronic devices and/or sensor suite may be used for experimentation and/or monitoring.

### Implementation Mechanisms

FIG. 9 depicts a general architecture of a computing system 900 (sometimes referenced herein as a user computing device). Computing system 900 and/or components of computing system 900 may be implemented by any of the devices discussed herein, such as user computing device 130 or application server 170 of FIG. 1B. The general architecture of the UAV computing system 900 depicted in FIG. 9 includes an arrangement of computer hardware and software components that may be used to implement aspects of the present disclosure. The computing system 900 may include many more (or fewer) elements than those shown in FIG. 9. It is not necessary, however, that all of these elements be shown in order to provide an enabling disclosure. As illustrated, the computing system 900 includes one or more hardware processors 904, a communication interface 918, a computer readable medium storage and/or device 910, one or more input devices 914A (such as a touch screen, mouse, keyboard, etc.), one or more output devices 916A (such as a monitor, screen, and/or display), and memory 906, some of which may communicate with one another by way of a communication bus 902 or otherwise. The communication interface 918 may provide connectivity to one or more networks or computing systems. The hardware processor(s) 904 may thus receive information and instructions from other computing systems or services via the network 922.

The memory 906 may contain computer program instructions (grouped as modules or components in some embodiments) that the hardware processor(s) 904 executes in order to implement one or more embodiments. The memory 906 generally includes RAM, ROM and/or other persistent, auxiliary or non-transitory computer-readable media. The memory 906 may store an operating system that provides computer program instructions for use by the hardware processor(s) 904 in the general administration and operation of the computing system 900. The memory 906 may further include computer program instructions and other information for implementing aspects of the present disclosure. For example, in one embodiment, the memory 906 includes a routing module that determines a route for a UAV. In addition, memory 906 may include or communicate with storage device 910. A storage device 910, such as a magnetic disk, optical disk, or USB thumb drive (Flash drive), etc., is provided and coupled to bus 902 for storing information, data, and/or instructions.

Memory 906 also may be used for storing temporary variables or other intermediate information during execution of instructions to be executed by hardware processor(s) 904. Such instructions, when stored in storage media accessible to hardware processor(s) 904, render computer system 900 into a special-purpose machine that is customized to perform the operations specified in the instructions.

In general, the word “instructions,” as used herein, refers to logic embodied in hardware or firmware, or to a collection of software modules, possibly having entry and exit points, written in a programming language, such as, but not limited to, Java, Lua, C, C++, or C#. A software module may be compiled and linked into an executable program, installed in a dynamic link library, or may be written in an interpreted programming language such as, but not limited to, BASIC, Perl, or Python. It will be appreciated that software modules may be callable from other modules or from themselves, and/or may be invoked in response to detected events or interrupts. Software modules configured for execution on computing devices by their hardware processor(s) may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the instructions described herein refer to logical modules that may be combined with other modules or divided into sub-modules despite their physical organization or storage.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 902. Transmission media can also take the form of acoustic or light waves, such as those generated during radio-wave and infra-red data communications.

Computing system 900 also includes a communication interface 918 coupled to bus 902. Communication interface 918 provides a two-way data communication to network 922. For example, communication interface sends and receives electrical, electromagnetic, or optical signals that carry digital data streams representing various types of information via cellular, packet radio, GSM, GPRS, CDMA, WiFi, satellite, radio, RF, radio modems, ZigBee, XBee, XRF, XTend, Bluetooth, WPAN, line of sight, satellite relay, or any other wireless data link.

Computing system 900 can send messages and receive data, including program code, through the network 922 and communication interface 918. A computing system 900 may communicate with other computing devices 930, such as an application server, via network 922.

Computing system 900 may include a distributed computing environment including several computer systems that are interconnected using one or more computer networks. The computing system 900 could also operate within a computing environment having a fewer or greater number of devices than are illustrated in FIG. 9.

Embodiments have been described in connection with the accompanying drawings. However, it should be understood that the figures are not drawn to scale. Distances, angles, etc. are merely illustrative and do not necessarily bear an exact relationship to actual dimensions and layout of the devices illustrated. In addition, the foregoing embodiments have been described at a level of detail to allow one of ordinary skill in the art to make and use the devices, systems, etc. described herein. A wide variety of variation is possible. Components, elements, and/or steps can be altered, added, removed, or rearranged. While certain embodiments have been explicitly described, other embodiments will become apparent to those of ordinary skill in the art based on this disclosure.

The preceding examples can be repeated with similar success by substituting generically or specifically described operating conditions of this disclosure for those used in the preceding examples.

Depending on the embodiment, certain acts, events, or functions of any of the methods described herein can be performed in a different sequence, can be added, merged, or left out altogether (e.g., not all described acts or events are necessary for the practice of the method). Moreover, in certain embodiments, acts or events can be performed concurrently, e.g., through multi-threaded processing, interrupt processing, or multiple processors or processor cores, rather than sequentially. In some embodiments, the algorithms disclosed herein can be implemented as routines stored in a memory device. Additionally, a processor can be configured to execute the routines. In some embodiments, custom circuitry may be used.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Each of the processes, methods, and algorithms described in the preceding sections may be embodied in, and fully or partially automated by, code instructions or software modules executed by one or more computing systems or computer processors comprising computer hardware. The processes and algorithms may be implemented partially or wholly in application-specific circuitry. A software module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

It should be noted that, despite references to particular computing paradigms and software tools herein, the computer program instructions with which embodiments of the present subject matter may be implemented may correspond to any of a wide variety of programming languages, software tools and data formats, and be stored in any type of volatile or nonvolatile, non-transitory computer-readable storage medium or memory device, and may be executed according to a variety of computing models including, for example, a client/server model, a peer-to-peer model, on a stand-alone computing device, or according to a distributed computing model in which various of the functionalities may be effected or employed at different locations. In addition, references to particular algorithms herein are merely by way of examples. Suitable alternatives or those later developed known to those of skill in the art may be employed without departing from the scope of the subject matter in the present disclosure.

It will also be understood by those skilled in the art that changes in the form and details of the implementations described herein may be made without departing from the scope of this disclosure. In addition, although various advantages, aspects, and objects have been described with reference to various implementations, the scope of this disclosure should not be limited by reference to such advantages, aspects, and objects. Rather, the scope of this disclosure should be determined with reference to the appended claims.

We claim:

1. An unmanned aerial vehicle (UAV) logistics system, comprising:
a computer system comprising at least one processor and memory, the at least one processor configured to:
receive a route request, the route request including an origin location and destination location for a UAV;
receive geospatial information associated with the origin location and the destination location, the geospatial information comprising at least one of physical obstacles and no-fly zones;
determine a route of the UAV from the origin location to the destination location based at least in part on the geo-spatial information; and
cause the route to be communicated to the UAV.

2. The system of claim 1, wherein the geospatial information is received from a cloud service application.

3. The system of claim 1, wherein the route is communicated to the UAV via a wireless communication.

4. The system of claim 1, wherein the route is communicated to the UAV via a cloud service application.

5. The system of claim 1, wherein the route is determined at a mobile electronic device and communicated to the UAV.

6. The system of claim 1, wherein the route is determined by a remote application and communicated to the UAV.

7. The system of claim 1, wherein the geospatial information includes vertical information and horizontal information.

8. The system of claim 1, wherein the processor is further configured to determine a horizontal route based on the geospatial information and determine a vertical route based on the geo-spatial information and the horizontal route.

9. The system of claim 1, wherein the geospatial information includes a minimum and maximum altitude for the route relative to ground.

10. The system of claim 1, wherein the process is further configured to generate an obstacle avoidance shape for the route based on the geospatial information.

11. The system of claim 1, wherein the processor is further configured to receive information from the UAV during flight and determine if the route should be altered.

12. The system of claim 1, wherein determining if the route should be altered, includes causing the UAV perform a controlled landing.

13. A computer-implemented method for dynamically determining a route for an unmanned aerial vehicle (UAV), comprising:
at a computer system including one or more processors and memory,
receiving a route request, the route request including an origin location and destination location for a UAV;
receiving geospatial information associated with the origin location and the destination location, the geospatial information comprising at least one of physical obstacles and no-fly zones;
determining a route of the UAV from the origin location to the destination location based at least in part on the geo-spatial information; and
and causing the route to be communicated to the UAV.

14. The method of claim 13, wherein the geospatial information is received from a cloud service application.

15. The system of claim 13, wherein the route is communicated to the UAV via a wireless communication.

16. The method of claim 13, wherein the route is communicated to the UAV via a cloud service application.

17. The method of claim 13, wherein the route is determined at a mobile electronic device and communicated to the UAV.

18. The method of claim 13, wherein the route is determined by a remote application and communicated to the UAV.

19. The method of claim 13, wherein the geospatial information includes vertical information and horizontal information.

20. The method of claim 13, further comprising determining a horizontal route based on the geospatial information and then determining a vertical route based on the geo-spatial information and the horizontal route.

21. The method of claim 13, wherein the geospatial information includes a minimum and maximum altitude for the route relative to ground.

22. A non-transitory computer-readable medium having instructions stored thereon, the instructions, when executed by at least one processor, cause the at least one processor to perform operations comprising:
receiving a route request, the route request including an origin location and destination location for a UAV;
receiving geospatial information associated with the origin location and the destination location, the geospatial information comprising at least one of physical obstacles and no-fly zones;
determining a route of the UAV from the origin location to the destination location based at least in part on the geo-spatial information; and
and causing the route to be communicated to the UAV.
